(19) United States
(12) Patent Application Publication
(10) Pub. No.: US 2012/0230278 A1
(43) Pub. Date: Sep. 13, 2012

(54) BASE STATION AND METHOD FOR MAPPING CONTROL CHANNEL

(75) Inventor: Hiroyoshi Sato, Kawasaki (JP)

(73) Assignee: FUJITSU LIMITED, Kawasaki-shi (JP)

(21) Appl. No.: 13/477,265

(22) Filed: May 22, 2012

Related U.S. Application Data
(63) Continuation of application No. PCT/JP2009/071822, filed on Dec. 29, 2009.

(51) Int. Cl. H04W 72/04; H04W 88/00

(52) U.S. Cl. 370/329

(57) ABSTRACT

A storage unit is provided corresponding to a symbol number of a resource element (RE) in a control channel region and stores a frequency number to indicate a resource element group (REG). A group detector detects a storage unit that stores the smallest frequency number of the frequency numbers, acquires the symbol number corresponding to the detected storage unit, and detects a REG by the acquired symbol number and the smallest frequency number. A mapping unit maps a control channel to the REG detected by the group detector. An adder adds a next frequency number value to indicate the next REG to which the control channel is mapped to the storage unit corresponding to the symbol number acquired by the group detector.

### CROSS-REFERENCE TO RELATED APPLICATION

This application is a continuation application of International Application PCT/JP2009/071822 filed on Dec. 29, 2009 and designated the U.S., the entire contents of which are incorporated herein by reference.

### FIELD

The embodiments discussed herein relate to a base station and a method for mapping a control channel.

### BACKGROUND

At present, in the 3GPP (3rd Generation Partnership Project), the long term evolution (LTE) is discussed. LTE specifies mapping of a reference signal, a control channel (control signal), a main signal including data etc., in the down link (DL) direction to a resource element (RE).

FIG. 8 illustrates a communication resource in the DL. The horizontal direction of the communication resource (resource grid) in FIG. 8 represents time and also represents orthogonal frequency division multiplexing (OFDM) symbols. The vertical direction represents frequency and also represents subcarriers.

Each rectangle illustrated in FIG. 8 represents an RE and represents the smallest time-frequency unit in the DL transmission. The thick frame represents a resource element group (REG: RE Group) formed by a plurality of REs.

It is possible to identify an RE by a frequency number k′ and a symbol number l′. For example, the RE of 11) illustrated in FIG. 8 may be represented as (k′, l′)=(3, 1).

It is possible for the control channel to use the OFDM symbol in a range of l′=0, l′=0, 1, or l′=0, 1, 2. The example in FIG. 8 illustrates a case where the three OFDM symbols of l′=0, 1, 2 are used for the control channel.

The OFDM symbols that the main signal may use are l′=m to 13. Here, m varies depending on the number of OFDM symbols used for the control channel. For example, in the example in FIG. 8, the three OFDM symbols of l′=0, 1, 2 are used for the control channel, and therefore, m is ‘3’ and it is possible for the main signal to use the 11 OFDM symbols of l′=3 to 13.

The frequency number k′ depends on the system bandwidth. For example, in LTE, when the system bandwidth is 5 MHz, the number of subcarriers is specified to be 300 and k′ takes values of 0 to 299.

To the control channel, REs are allocated in a REG. In the first column l′=0 of the communication resource, to the control channel, six REs are allocated as one REG. In the second column and the third column l′=1, 2, four REs are allocated as one REG.

In the first column l′=0, a reference signal for a terminal to receive a signal from the base station is allocated to every three REs. For example, the reference signal is allocated to the REs 1), 10), 19), . . . , to which oblique lines in the direction from the bottom right toward the top left are attached. The location of the reference signal is determined in advance. For example, in the case of FIG. 8, the reference signal is arranged in a REG in the first column, and therefore, the number of REs in the first column is six while four in the second column and in the third column. To the control channel, four resource elements are allocated also in the REG in the first column as in other OFDM symbols.

To the main signal, REs are allocated with 12 subcarriers as one unit. For example, in the case of the example in FIG. 8, the three ODFM symbols are used for the control channel, and therefore, to the main signal, 12 (subcarriers)×11 (OFDM symbols) REs are allocated as one unit. In the following, a region to which the control channel is allocated is sometimes called a control channel region and a region to which the main signal is allocated as a main signal region.

The control channel includes a physical control format indicator channel (PCFICH), a physical hybrid-ARQ indicator channel (PHICH), and a physical downlink control channel (PDCCH). PCFICH is a control channel to notify the terminal of the number of OFDM symbols allocated to the control channel region. PHICH is a control channel to notify the terminal of ACK/NACK for the up link (UL) data from the terminal. PDCCH is a control channel to indicate information about allocation by a scheduler of a physical downlink shared channel (PDSCH) and a physical uplink shared channel (PUSCH) and format information, such as a modulation method and encoding rate.

For example, according to Chapter 6.8.5 of TS 36.211 of 3GPP, the base station maps PDCCH to an empty REG after mapping PCFICH and PHICH to REGs in the control channel region based on a predetermined algorithm. For example, when mapping PCFICH and PHICH to REGs to which oblique lines in the direction from the bottom left toward the top right are attached, then the base station maps PDCCH to a REG to which oblique lines in the direction from the bottom left toward top right are not attached.

Here, a REG is indicated by (k′, l′) of the RE at the lowermost in the thick frame illustrated in FIG. 8 (indicated by the smallest frequency number in the thick frame) as an index. For example, REGs in FIG. 8 are indicated by (0, 0), (0, 1), (0, 2), (4, 1), (4, 2), (6, 0), (8, 1), (8, 2), . . . . The base station stores the indexes of the REGs in, for example, a memory.

When detecting a REG of the communication resource, the base station varies the value of (k′, l′) in such a manner so as to indicate the REs one by one as 1), 2), 3), 4), 5), . . . in FIG. 8 and thus detects a REG. For example, when (k′, l′) varied by the base station agrees with the index of a REG stored in the memory, the base station determines that the index corresponds to the REG. When determining that the index corresponds to the REG, the base station determines whether one of PCFICH and PHICH is mapped to the REG and if not, the base station maps PDCCH.

FIG. 9 is a flowchart illustrating mapping of PDCCH by the base station. In the following, it is assumed that the control channel region of the communication resource is l′=0 to 2 and k′=0 to 299.

(Step S101) The base station initializes m′ (REG number) and k′ to ‘0’.

(Step S102) The base station repeats processing of Loop #1 until k′ reaches 299 (25*12−1).

(Step S103) The base station initializes l′ to 0.

(Step S104) The base station determines whether or not (k′, l′) corresponds to a REG by comparing (k′, l′) with the indexes of REGs stored in the memory. When determining that (k′, l′) corresponds to a REG, the base station proceeds to step S105. When determining that (k′, l′) does not correspond to a REG, the base station proceeds to step S107.

(Step S105) The base station determines whether or not one of PCFICH and PHICH is mapped to the REG. When determining that PCFICH or PHICH is not mapped to the REG, the base station proceeds to step S106. When determining that one of PCFICH and PHICH is mapped to the REG, the base station proceeds to step S107.

For example, in the case of the REGs of (4, 2), (6, 0), . . . , the base station determines that one of PCFICH and PHICH is mapped to the REG and proceeds to step S107.

(Step S106) The base station maps PDCCH corresponding to four REs to the REG while adding 1 to m′.

(Step S107) The base station adds 1 to l′.

(Step S108) The base station determines whether or not l′ is less than 3. When l′ is less than 3, the base station proceeds to step S104. When l′ is not less than 3, the base station proceeds to step S109.

(Step S109) The base station adds 1 to k′.

There are known a radio terminal device and a radio base station device that appropriately arrange control information to a radio resource in the down link of a radio system of the evolved UMTS terrestrial radio access (E-UTRA) system etc. (for example, see Japanese Laid-Open Patent Publication No. 2009-49579). Further, there is known a radio communication system that adds and transmits new information at a timing as early as possible in the synchronization process (for example, see Japanese Laid-Open Patent Publication No. 2008-236383).

However, the conventional method has such a problem that the load of the mapping processing of the control channel is large because all the REs in the control channel region are determined sequentially whether or not to correspond to a REG.

For example, in FIG. 8, the base station determines whether or not an RE corresponds to a REG for all the REs sequentially in the order of 1), 2), 3), 4), 5), . . . . Then, when an RE corresponds to a REG, the base station determines whether one of PCFICH and PHICH is not mapped to the REG. Because of this, the base station determines that ⅚ of REs do not correspond to a REG in the first column of l′=0 and ¾ of REs do not correspond to a REG in the second column and the third column of l′=1, 2. That is, the base station determines that at least ¾ of REs do not correspond to a REG, and as a result, ¾ or more of the whole processing may be wasteful.

### SUMMARY

According to an aspect, a base station that performs allocation of a radio resource has a mapping unit configured to allocate a control channel to a resource element group in a control channel region including a plurality of resource elements defined in a time direction and in a frequency direction and identified based on symbol numbers indicating the time direction and frequency numbers indicating the frequency direction, a storage unit provided corresponding to the symbol number of the resource element in the control channel region and storing the frequency numbers to indicate the resource element group, a group detector configured to detect the storage unit that stores the smallest frequency number of the frequency numbers and to detect the resource element group based on the symbol number corresponding to the detected storage unit and the smallest frequency number, and an adder configured to add a predetermined value to indicate a resource element group to which the next control channel is allocated to the smallest frequency number.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a base station according to a first embodiment;

FIG. 2 illustrates a radio system to which a base station according to a second embodiment is applied;

FIG. 3 is a block diagram of a base station;

FIG. 4 is a block diagram of a baseband signal processor;

FIG. 5 illustrates a communication resource in a DL;

FIG. 6 is a flowchart illustrating processing to map PDCCH;

FIG. 7 is a flowchart illustrating processing to detect the smallest value of a temporary register;

FIG. 8 illustrates a communication resource in a DL; and

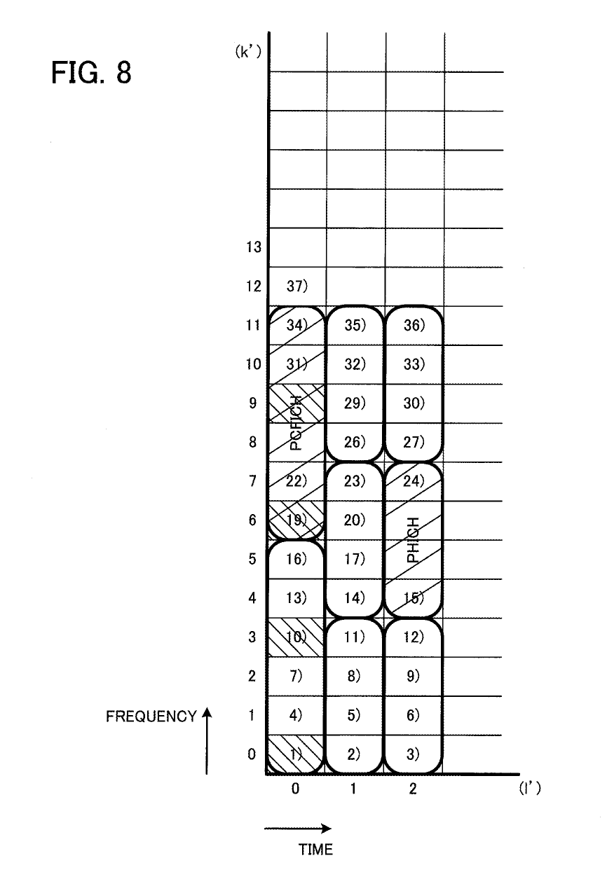

FIG. 9 is a flowchart illustrating mapping of PDCCH by a base station.

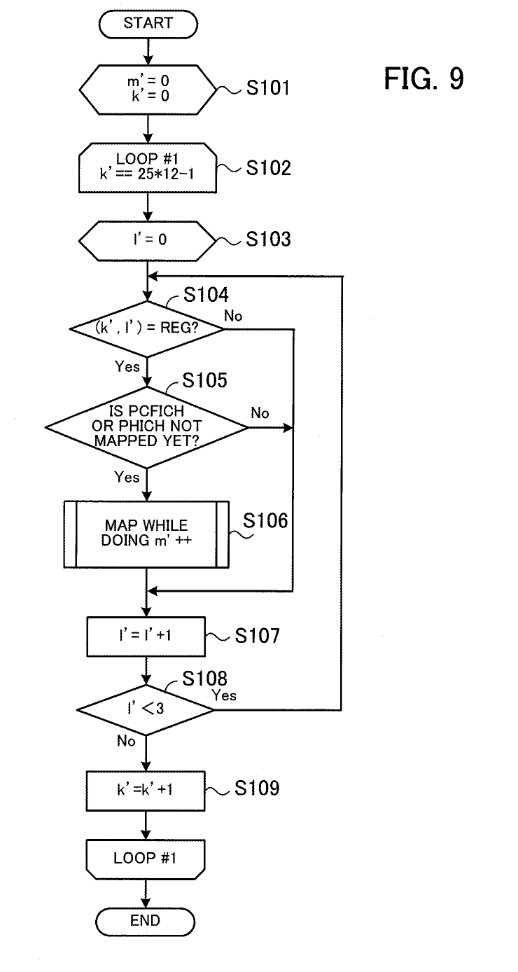

### DESCRIPTION OF EMBODIMENTS

Hereinafter, a first embodiment is explained in detail with reference to the accompanying drawings, wherein like reference numerals refer to like elements throughout.

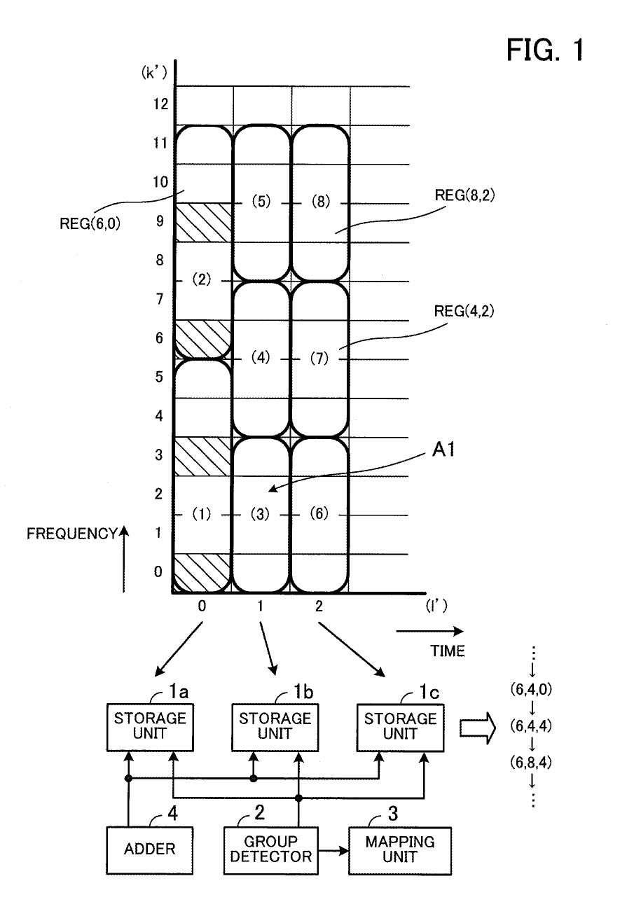

FIG. 1 illustrates a base station according to the first embodiment. FIG. 1 also illustrates a communication resource of a DL for the base station and a terminal to perform radio communication. The horizontal axis of the communication resource in FIG. 1 represents a time direction and the vertical axis represents a frequency direction. Each rectangle illustrated in the communication resource represents an RE. The oblique lines in the direction from the bottom right toward the top left illustrated in FIG. 1 indicate an RE to be allocated to a reference signal.

An RE is identified by a symbol number l′ in the time direction and a frequency number k′ in the frequency direction. For example, the RE indicated by an arrow A1 illustrated in FIG. 1 is identified as (k′, l′)=(2, 1). The control channel is mapped to, for example, a REG in the control channel region of l′=0 to 2 and k′=0 to 299 and transmitted to the terminal.

As illustrated in FIG. 1, the base station has storage units 1a to 1c, a group detector 2, a mapping unit 3, and an adder 4.

The storage units 1a to 1c are provided corresponding to the symbol numbers l′=0 to 2 of the REs in the control channel region. For example, as illustrated in FIG. 1, the storage unit 1a is provided corresponding to l′=0, the storage unit 1b is provided corresponding to l′=1, and the storage unit 1c is provided corresponding to l′=2. In the storage units 1a to 1c, the frequency number k′ to indicate a REG with a thick frame is stored.

A REG is indicated by the symbol number and the smallest frequency number of the RE within the REG. For example, the REG of (2) illustrated in FIG. 1 may be indicated as (6, 0) and the REG of (8) illustrated in FIG. 1 may be indicated as (8, 2).

Consequently, it is possible to indicate a REG by the storage unit 1a, 1b, or 1c provided corresponding to the symbol number and the contents stored therein. For example, when ‘6’ is stored in the storage unit 1a, it is possible to indicate the REG (6, 0) of (2) in FIG. 1 because the storage unit 1a corresponds to the symbol number ‘0’ and when ‘4’ is stored in the storage unit 1c, it is possible to indicate the REG (4, 2) of (7) in FIG. 1 because the storage unit 1c corresponds to the symbol number ‘2’.

The group detector 2 detects the storage unit 1a, 1b, or 1c that stores the frequency number that is smallest (hereinafter, sometimes referred to simply as the smallest frequency number), acquires the symbol number corresponding to the detected storage unit 1a, 1b, or 1c, and detects a REG by the acquired symbol number and the smallest frequency number.

For example, it is assumed that 6, 4, and 0 are stored in the storage units 1a to 1c, respectively. In this case, the group detector 2 detects the storage unit 1c that stores the smallest frequency number ‘0’ of the storage units 1a to 1c and acquires the symbol number l′=2 corresponding to the detected storage unit 1c. Then, the group detector 2 detects the REG of (6) of the communication resource illustrated in FIG. 1 by the smallest frequency number ‘0’ and the symbol number ‘2’.

The mapping unit 3 maps the control channel to the REG detected by the group detector 2. In the case of the example described above, the mapping unit 3 maps the control channel to the REG (0, 2) of (6) illustrated in FIG. 1.

The adder 4 adds a predetermined offset value to indicate the next REG to which the control channel is mapped to the smallest frequency number stored in the storage unit 1a, 1b, or 1c corresponding to the symbol number acquired by the group detector 2.

In the case of the example described above, the adder 4 adds an offset value of ‘4’ to indicate the next REG to which the control channel is mapped to the smallest frequency number stored in the storage unit 1c corresponding to the symbol number l′=2 acquired by the group detector 2. Thereby, the storage unit 1c indicates the REG (4, 2) to which the control channel is to be mapped next instead of the REG (0, 2) on l′=2 to which the control channel has been mapped.

Consequently, the contents stored in the storage units 1a to 1c change to (6, 4, 4), respectively. The group detector 2 detects the storage unit 1a, 1b, or 1c that stores the smallest frequency number again, acquires the symbol number corresponding to the detected storage unit 1a, 1b, or 1c, and detects a REG by the acquired symbol number and the smallest frequency number in the same manner as described above.

When the storage units 1a to 1c that store the smallest frequency number exist in plural number, the group detector 2 detects the storage unit 1a, 1b, or 1c with the smallest symbol number and acquires the symbol number corresponding to the detected storage unit 1a, 1b, or 1c. In the case of the example described above, the contents stored in the storage units 1a to 1c are (6, 4, 4), and therefore, the group detector 2 detects the storage unit 1b and acquires the symbol number ‘1’. The mapping unit 3 maps the control channel to the REG detected by the group detector 2 in the same manner as described above and the adder 4 adds an offset value of ‘4’ to indicate the REG to which the next control channel is to be mapped to the storage unit 1b corresponding to the symbol number ‘1’ acquired by the group detector 2. Consequently, the contents stored in the storage units 1a to 1c change to (6, 8, 4).

As described above, the base station provides the storage units 1a to 1c corresponding to the symbol number of the RE in the control channel region and stores a frequency number to indicate a REG in the storage units 1a to 1c. The base station detects the storage unit 1a, 1b, or 1c that stores the smallest frequency number of the frequency numbers, acquires the symbol number corresponding to the detected storage unit 1a, 1b, or 1c, and detects a REG by the acquired symbol number and the smallest frequency number. The base station adds an offset value to indicate the next REG to the storage unit 1a, 1b, or 1c corresponding to the acquired symbol number.

Thereby, in the storage units 1a to 1c, the frequency number that indicates a REG corresponding to each symbol number is stored. It is not necessary for the base station to determine whether or not an RE corresponds to a REG sequentially for all the REs in the control channel region, and therefore, it is possible to reduce the load of processing to map the control channel to a REG.

Next, a second embodiment is explained in detail with reference to the drawings.

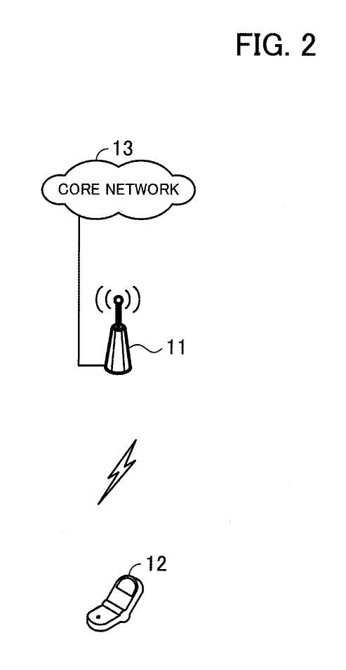

FIG. 2 illustrates a radio system to which a base station according to the second embodiment is applied. FIG. 2 includes a base station 11, a terminal 12, and a core network 13. The base station 11 is connected to the core network 13 and performs radio communication with the terminal 12 based on, for example, the radio system of LTE. The terminal 12 is, for example, a mobile telephone etc.

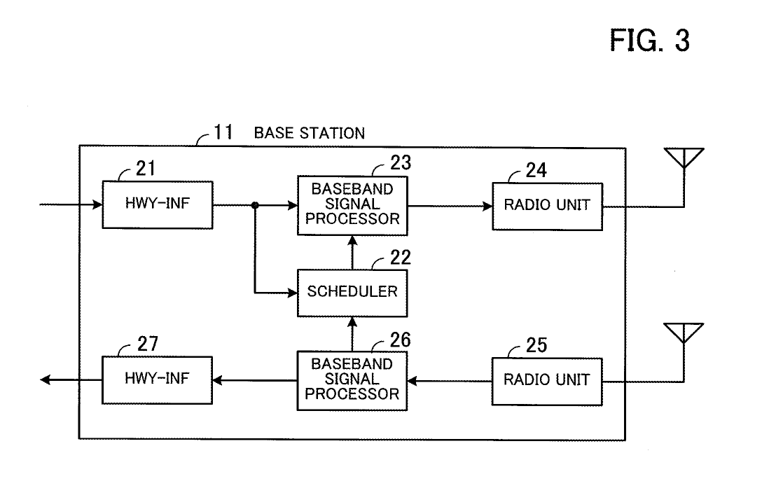

FIG. 3 is a block diagram of the base station. As illustrated in FIG. 3, the base station 11 has highway interfaces (HWY-INF) 21 and 27 that are interface units, a scheduler 22, baseband signal processors 23 and 26, and radio units 24 and 25.

The HWY-INF 21 receives data from the core network 13. The HWY-INF 21 outputs the received data to the scheduler 22 and the baseband signal processor 23.

The scheduler 22 generates a control channel based on data output from the HWY-INF 21 and data output from the baseband signal processor 26. Further, the scheduler 22 performs scheduling of user data to be transmitted to the terminal 12 based on data output from the HWY-INF 21 and data output from the baseband signal processor 26.

The baseband signal processor 23 performs processing to transmit user data received from the core network 13 to the terminal 12. For example, the baseband signal processor 23 performs subcarrier modulation of data received from the core network 13 based on scheduling of the scheduler 22. Further, the baseband signal processor 23 performs subcarrier modulation of the control channel generated in the scheduler 22.

The radio unit 24 up-converts a subcarrier-modulated signal that is output from the baseband signal processor 23 into a radiofrequency and radio-transmits the signal to the terminal 12 via an antenna.

The radio unit 25 down-converts the signal of the terminal 12 received via the antenna into a frequency of a baseband signal.

The baseband signal processor 26 performs demodulation processing of the baseband signal output from the radio unit 25. The baseband signal processor 26 outputs control information obtained from the demodulated signal to the scheduler 22 and outputs demodulated data to the HWY-INF 27.

The HWY-INF 27 sends out demodulated data of the terminal 12 to the core network 13.

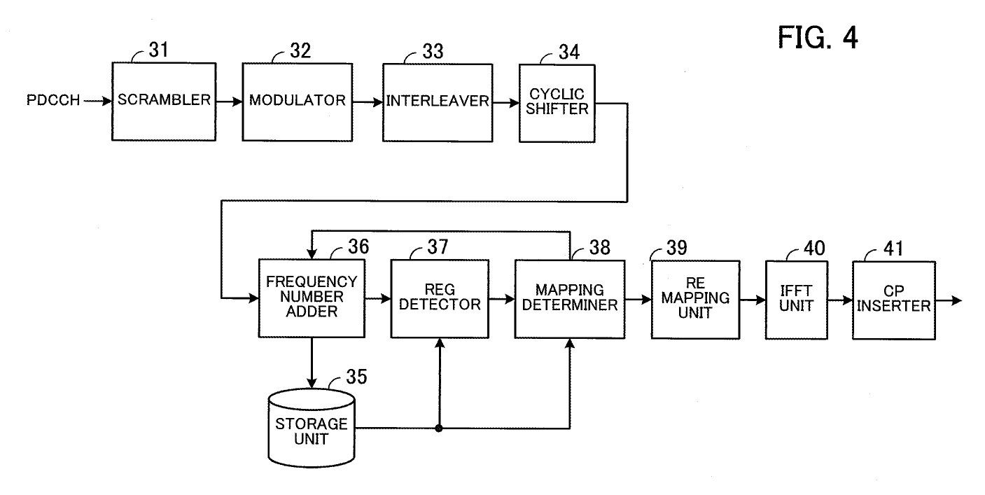

FIG. 4 is a block diagram of the baseband signal processor. FIG. 4 illustrates a block of the baseband signal processor 23 in FIG. 3. The baseband signal processor 23 has a scrambler 31, a modulator 32, an interleaver 33, a cyclic shifter 34, a storage unit 35, a frequency number adder 36, a REG detector 37, a mapping determiner 38, an RE mapping unit 39, an inverse fast Fourier transform (IFFT) unit 40, and a cyclic prefix (CP) inserter 41.

To the scrambler 31, PDCCH generated by the scheduler 22 is channel-coded and input. The scrambler 31 performs scramble processing on PDCCH that is input and outputs the PDCCH to the modulator 32.

The modulator 32 modulates the scramble-processed PDCCH. The modulator 32 modulates the PDCCH by, for example, quadrature phase shift keying (QPSK) or quadrature amplitude modulation (QAM).

The interleaver 33 rearranges data of the modulated PDCCH.

The cyclic shifter 34 cyclically shits the bits of the rearranged data by a predetermined amount.

In the storage unit 35, for example, a temporary register that stores an index that indicates a REG is formed. The temporary registers are formed in the number corresponding to the number of OFDM symbols to which the control channel may be mapped.

For example, when the number of OFDM symbols to which the control channel may be mapped is ‘1’ (l′=0), the ‘1’ temporary register is formed. When the number of OFDM symbols to which the control channel may be mapped is ‘2’ (l′=0, 1), the ‘2’ temporary registers are formed. When the number of OFDM symbols to which the control channel may be mapped is ‘3’ (l′=0, 1, 2), the ‘3’ temporary registers are formed. It may also be possible to form one or more temporary registers in each of the plurality of storage units 35.

Here, the values of the temporary registers are expressed in the form of (10, 11, 12) when, for example, three temporary registers are formed in the storage unit 35. The value 10 represents the value of k′ of a REG on l′=0, 11 represents the value of k′ of a REG on l′=1, and represents the value of k′ of a REG on l′=2. Consequently, for example, when the values of the temporary registers are (6, 4, 4), it is known that REGs are (6, 0), (4, 1), and (4, 2).

The frequency number adder 36 adds a predetermined value to the temporary register so that the temporary register of the storage unit 35 indicates a REG. The number of REs in a REG to which the control channel is mapped is determined by the symbol number and the predetermined value is the number of REs determined by the symbol number.

For example, the control channel is allocated with six REs as one REG on l′=0 in the first column of the communication resource and allocated with four REs as one REG on l′=1, 2 in the second column and the third column of the communication resource. Consequently, the frequency number adder 36 adds ‘6’ to 10, adds ‘4’ to 11, and adds ‘4’ to 12 of (10, 11, 12).

The REG detector 37 detects the temporary register that stores the smallest frequency number and acquires the symbol number l′ corresponding to the detected temporary register. When the temporary register that stores the smallest frequency number exists in plural number, the REG detector 37 detects the temporary register with the smallest symbol number and acquires the symbol number l′ corresponding to the detected temporary register.

For example, in the case of (6, 4, 4), there exist two temporary registers having the smallest value of the temporary register, that is, l′=1, 2. In this case, the REG detector 37 detects the temporary register corresponding to l′=1, the smallest symbol number, and acquires the symbol number ‘1’.

The REG detector 37 acquires the value of the temporary register corresponding to the acquired symbol number. For example, in the case of the example described above, the value of the temporary register corresponding to the acquired symbol number l′=1 is ‘4’, and therefore, the REG detector 37 acquires ‘4’.

The REG detector 37 detects the acquired symbol number and the value of the temporary register corresponding to the acquired symbol number as the index of a REG. In the case of the example described above, the REG detector 37 detects (4, 1) as the index of a REG.

The mapping determiner 38 determines whether one of PCFICH and PHICH is not mapped to the REG detected by the REG detector 37.

For example, PCFICH and PHICH are mapped to a REG based on the scheduler 22 and the index of the REG is stored in the storage unit 35. The mapping determiner 38 compares the index of the REG stored in the storage unit 35 and the index of the REG detected by the REG detector 37 and determines whether or not one of PCFICH and PHICH is mapped to the REG detected by the REG detector 37.

The frequency number adder 36, the REG detector 37, and the mapping determiner 38 are formed by, for example, a DSP (Digital Signal Processor), a CPU (Central Processing Unit), or a dedicated semiconductor storage unit.

The RE mapping unit 39 maps PDCCH to the REG detected by the REG detector 37 based on the determination result of the mapping determiner 38. The RE mapping unit 39 maps PDCCH to the detected REG when it is determined that PCFICH or PHICH is not mapped to the REG detected by the REG detector 37 by the mapping determiner 38. Further, the RE mapping unit 39 maps user data (main signal) to the main signal region of the communication resource based on the scheduling of the scheduler 22.

The IFFT unit 40 converts a signal mapped onto the frequency axis (subcarrier) into a signal on the time axis. The CP inserter 41 copies the rear end part of the signal converted onto the time axis to the tip end part.

Mapping of PDCCH to a REG using a communication resource is explained.

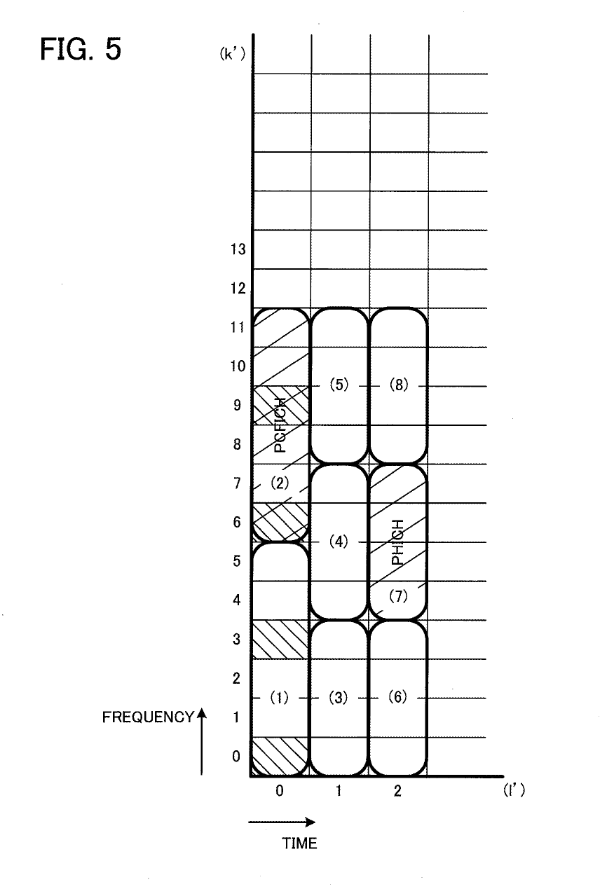

FIG. 5 illustrates a communication resource in the DL. First, the frequency number adder 36 forms a temporary register in the storage unit 35 corresponding to the number of OFDM symbols to which the control channel may be mapped. In FIG. 5, the number of OFDM symbols to which the control channel may be mapped is three and three temporary registers A, B, and C are formed and the temporary registers A, B, and C are caused to correspond to symbol numbers l′=0, l′=1, and l′=2, respectively. The temporary registers A, B, and C are initialized to (0, 0, 0) when the control channel is mapped to REs. It is assumed that the system bandwidth is 5 MHz.

The REG detector 37 detects the temporary register A, B, or C the value (that is, value of k′) of which is the smallest value and acquires the symbol number corresponding to the detected temporary register A, B, or C. When there exist two or more temporary registers the value of which is the smallest value, the REG detector 37 detects the temporary register with the smallest symbol number and acquires the symbol number corresponding to the detected register A, B, or C.

For example, in the case of (0, 0, 0), there exist three temporary registers that take the smallest value. Consequently, in this case, the REG detector 37 acquires the smallest symbol number l′=0.

The REG detector 37 acquires the value of the temporary register corresponding to the acquired symbol number. In the case of (0, 0, 0) in the example described above, the REG detector 37 acquires the value of the temporary register A corresponding to the symbol number l′=0. The temporary register A indicates the value of k′ corresponding to a REG on l′=0, and l′=0 and k′=0 detected by the REG detector 37 represent the index of the REG indicated by (1) in FIG. 5.

The mapping determiner 38 determines whether or not one of PCFICH and PHICH is mapped to the REG detected by the REG detector 37. In the example of FIG. 5, PHICH is mapped to (4, 2) and PCFICH is mapped to (6, 0). Consequently, the mapping determiner 38 determines that PCFICH or PHICH is not mapped to the REG of (0, 0) detected by the REG detector 37.

The RE mapping unit 39 maps PDCCH to the REG detected by the REG detector 37 based on the determination result of the mapping determiner 38. In the case of the example described above, the mapping determiner 38 determines that PCFICH or PHICH is not mapped to the REG detected by the REG detector 37, and therefore, the RE mapping unit 39 maps PDCCH to the REG detected by the REG detector 37.

When the determination of the mapping determiner 38 is completed, the frequency number adder 36 adds a predetermined value to the temporary register corresponding to the symbol number acquired by the REG detector 37 so as to indicate k′ of the next REG. In the case of the example described above, the REG detector 37 has acquired the symbol number l′=0, and therefore, the frequency number adder 36 adds 6 to the temporary register A. Because of this, the temporary register A indicates k′ of the next REG on l′=0.

The REG detector 37 detects the temporary register A, B, or C that stores the frequency number of the smallest value after the update by the frequency number adder 36 and acquires the symbol number corresponding to the detected temporary register A, B, or C. When there exist two or more temporary registers that store the frequency number of the smallest value, the REG detector 37 detects the temporary register with the smallest symbol number and acquires the symbol number corresponding to the detected temporary register.

For example, in the case of (6, 0, 0), there exist two symbol numbers having the smallest value of the temporary register. Consequently, the REG detector 37 acquires the smallest symbol number l′=1.

The REG detector 37 acquires the value of the temporary register corresponding to the acquired symbol number. For example, in the case of (6, 0, 0), the REG detector 37 acquires the value of the temporary register B corresponding to the acquired symbol number l′=1. The temporary register B represents the value of k′ of a REG on l′=1, and l′=1 and k′=0 acquired by the REG detector 37 represent the index of the REG indicated by (3) in FIG. 5.

The mapping determiner 38 determines whether or not one of PCFICH and PHICH is mapped to the REG detected by the REG detector 37. In the example in FIG. 5, PHICH is mapped to (4, 2) and PCFICH is mapped to (6, 0), and therefore, the mapping determiner 38 determines that PCFICH or PHICH is not mapped to the REG of (0, 1) detected by the REG detector 37.

The RE mapping unit 39 maps PDCCH to the REG detected by the REG detector 37 based on the determination result of the mapping determiner 38. In the case of the example described above, the RE mapping unit 39 maps PDCCH to the REG of (0, 1) detected by the REG detector 37.

When the determination of the mapping determiner 38 is completed, the frequency number adder 36 adds a predetermined value to the temporary register corresponding to the symbol number acquired by the REG detector 37 so as to indicate k′ of the next REG. In the case of the example of (6, 0, 0) described above, the frequency number adder 36 adds 4 to 11. Consequently, the temporary registers change to (6, 4, 0) and the index of the next REG on l′=1 to which the control channel is mapped changes to k′=4.

The REG detector 37 detects the temporary register A, B, or C that stores the frequency number of the smallest value after the update by the frequency number adder 36 and acquires the symbol number corresponding to the detected temporary register A, B, or C. When there exist two or more temporary registers that store the frequency number of the smallest value, the REG detector 37 detects the temporary register with the smallest symbol number and acquires the symbol number corresponding to the detected temporary register.

For example, in the case of (6, 4, 0), there exists one symbol number having the smallest value of the temporary register. Consequently, the REG detector 37 acquires the symbol number l′=2.

The REG detector 37 acquires the value of the temporary register corresponding to the acquired symbol number. For example, in the case of (6, 4, 0), the REG detector 37 acquires the value of the temporary register C corresponding to the acquired symbol number l′=2. The temporary register C represents the value of k′ of a REG on l′=2, and l′=2 and k′=0 acquired by the REG detector 37 represent the index of the REG indicated by (6) in FIG. 5.

The mapping determiner 38 determines whether or not one of PCFICH and PHICH is mapped to the REG detected by the REG detector 37. In the example in FIG. 5, PHICH is mapped to (4, 2) and PCFICH is mapped to (6, 0), and therefore, the mapping determiner 38 determines that PCFICH or PHICH is not mapped to the REG of (0, 2) detected by the REG detector 37.

The RE mapping unit 39 maps PDCCH to the REG detected by the REG detector 37 based on the determination result of the mapping determiner 38. In the case of the example described above, the RE mapping unit 39 maps PDCCH to the REG of (0, 2) detected by the REG detector 37.

When the determination of the mapping determiner 38 is completed, the frequency number adder 36 adds a predetermined value to the temporary register corresponding to the symbol number acquired by the REG detector 37 so as to indicate k′ of the next REG. In the case of the example of (6, 4, 0) described above, the frequency number adder 36 adds 4 to 12. Consequently, the temporary registers change to (6, 4, 4) and the index of the next REG on l′=2 to which the control channel is mapped changes to k′=4.

The REG detector 37 detects the temporary register A, B, or C that stores the frequency number of the smallest value after the update by the frequency number adder 36 and acquires the symbol number corresponding to the detected temporary register A, B, or C. When there exist two or more temporary registers that store the frequency number of the smallest value, the REG detector 37 detects the temporary register with the smallest symbol number and acquires the symbol number corresponding to the detected temporary register.

For example, in the case of (6, 4, 4), there exist two symbol numbers having the smallest value of the temporary register. Consequently, the REG detector 37 acquires the smallest symbol number l′=1.

The REG detector 37 acquires the value of the temporary register corresponding to the acquired symbol number. For example, in the case of (6, 4, 4), the REG detector 37 acquires the value of the temporary register B corresponding to the acquired symbol number l′=1. The temporary register B represents the value of k′ of a REG on l′=1, and l′=1 and k′=4 detected by the REG detector 37 represent the index of the REG indicated by (4) in FIG. 5.

The mapping determiner 38 determines whether or not one of PCFICH and PHICH is mapped to the REG detected by the REG detector 37. In the example in FIG. 5, PHICH is mapped to (4, 2) and PCFICH is mapped to (6, 0), and therefore, the mapping determiner 38 determines that PCFICH or PHICH is not mapped to the REG of (4, 1) detected by the REG detector 37.

The RE mapping unit 39 maps PDCCH to the REG detected by the REG detector 37 based on the determination result of the mapping determiner 38. In the case of the example described above, the RE mapping unit 39 maps PDCCH to the REG of (4, 1) detected by the REG detector 37.

When the determination of the mapping determiner 38 is completed, the frequency number adder 36 adds a predetermined value to the temporary register corresponding to the symbol number acquired by the REG detector 37 so as to indicate k′ of the next REG. In the case of the example of (6, 4, 4) described above, the frequency number adder 36 adds 4 to 11. Consequently, the temporary registers change to (6, 8, 4) and the index of the next REG on l′=1 to which the control channel is mapped changes to k′=8.

The REG detector 37 detects the temporary register A, B, or C that stores the frequency number of the smallest value after the update by the frequency number adder 36 and acquires the symbol number corresponding to the detected temporary register A, B, or C. When there exist two or more temporary registers that store the frequency number of the smallest value, the REG detector 37 detects the temporary register with the smallest symbol number and acquires the symbol number corresponding to the detected temporary register.

For example, in the case of (6, 8, 4), there exists one symbol number having the smallest value of the temporary register. Consequently, the REG detector 37 acquires the symbol number l′=2.

The REG detector 37 acquires the value of the temporary register corresponding to the acquired symbol number. For example, in the case of (6, 8, 4), the REG detector 37 acquires the value of the temporary register C corresponding to the acquired symbol number l′=2. The temporary register C represents the value of k′ of a REG on l′=2, and l′=2 and k′=4 detected by the REG detector 37 represent the index of the REG indicated by (7) in FIG. 5.

The mapping determiner 38 determines whether or not one of PCFICH and PHICH is mapped to the REG detected by the REG detector 37. In the example in FIG. 5, PHICH is mapped to (4, 2) and PCFICH is mapped to (6, 0), and therefore, the mapping determiner 38 determines that PHICH is mapped to the REG of (4, 2) detected by the REG detector 37.

The RE mapping unit 39 maps PDCCH to the REG detected by the REG detector 37 based on the determination result of the mapping determiner 38. In the case of the example described above, the RE mapping unit 39 does not map PDCCH to the REG of (4, 2) detected by the REG detector 37.

When the determination of the mapping determiner 38 is completed, the frequency number adder 36 adds a predetermined value to the temporary register corresponding to the symbol number acquired by the REG detector 37 so as to indicate k′ of the next REG. In the case of the example of (6, 8, 4) described above, the frequency number adder 36 adds 4 to 12. Consequently, the temporary registers change to (6, 8, 8) and the index of the next REG on l′=2 to which the control channel is mapped changes to k′=8.

The REG detector 37 detects the temporary register A, B, or C that stores the frequency number of the smallest value after the update by the frequency number adder 36 and acquires the symbol number corresponding to the detected temporary register A, B, or C. When there exist two or more temporary registers that store the frequency number of the smallest value, the REG detector 37 detects the temporary register with the smallest symbol number and acquires the symbol number corresponding to the detected temporary register.

For example, in the case of (6, 8, 8), there exists one symbol number having the smallest value of the temporary register. Consequently, the REG detector 37 acquires the symbol number l′=0.

The REG detector 37 acquires the value of the temporary register corresponding to the acquired symbol number. For example, in the case of (6, 8, 8), the REG detector 37 acquires the value of the temporary register A corresponding to the acquired symbol number l′=0. The temporary register A represents the value of k′ of a REG on l′=0, and l′=0 and k′=6 detected by the REG detector 37 represent the index of the REG indicated by (2) in FIG. 5.

The mapping determiner 38 determines whether or not one of PCFICH and PHICH is mapped to the REG detected by the REG detector 37. In the example in FIG. 5, PHICH is mapped to (4, 2) and PCFICH is mapped to (6, 0), and therefore, the mapping determiner 38 determines that PCFICH is mapped to the REG of (6, 0) detected by the REG detector 37.

The RE mapping unit 39 maps PDCCH to the REG detected by the REG detector 37 based on the determination result of the mapping determiner 38. In the case of the example described above, the RE mapping unit 39 does not map PDCCH to the REG of (6, 0) detected by the REG detector 37.

When the determination of the mapping determiner 38 is completed, the frequency number adder 36 adds a predetermined value to the temporary register corresponding to the symbol number acquired by the REG detector 37 so as to indicate k′ of the next REG. In the case of the example of (6, 8, 8) described above, the frequency number adder 36 adds 6 to 10. Consequently, the temporary registers change to (12, 8, 8) and the index of the next REG on l′=0 to which the control channel is mapped changes to k′=12.

After the above, the base station 11 searches for a REG in the control channel region and maps PDCCH in the same manner.

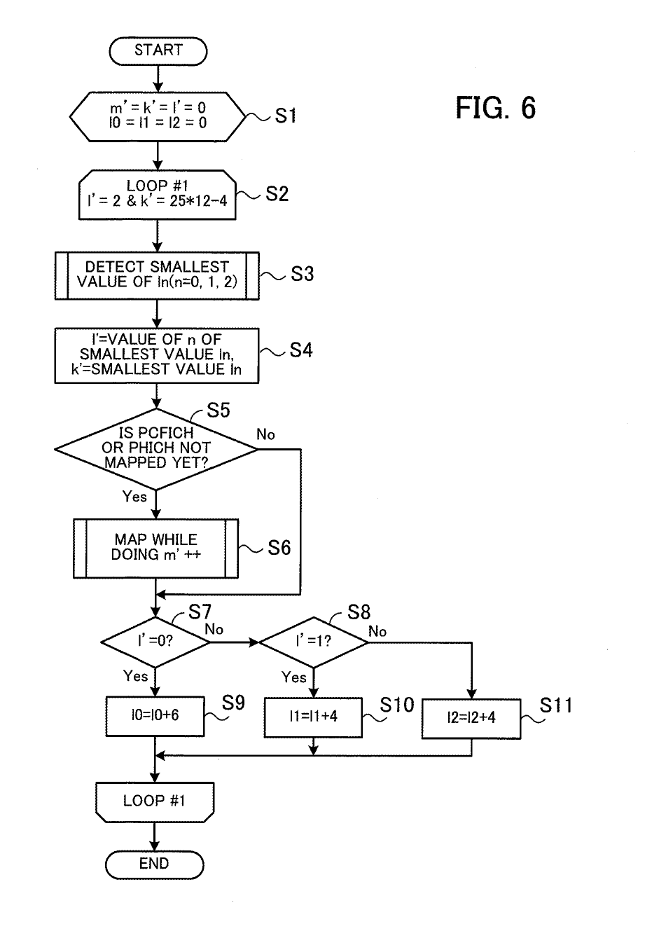

FIG. 6 is a flowchart illustrating processing to map PDCCH. In the following, explanation is given on the assumption that the number of OFDM symbols to which the control channel may be mapped is three (l′=0, 1, 2) and the system bandwidth is 5 MHz (number of subcarriers is 300).

(Step S1) The frequency number adder 36 initializes m′, k′, and l′ to ‘0’. Further, the frequency number adder 36 forms the three temporary registers A, B, and C in the storage unit 35. The frequency number adder 36 initializes the values (10, 11, 12) of the temporary registers A, B, and C to ‘0’.

(Step S2) The REG detector 37 repeats the processing of Loop #1 until the smallest symbol number that is acquired is l′=2 and k′=25*12−4 is reached.

(Step S3) The REG detector 37 detects the smallest value ln (n=0, 1, 2) of the temporary registers.

(Step S4) The REG detector 37 takes n of the detected smallest value ln of the temporary register to be the value of l′. That is, the REG detector 37 acquires the symbol number with which the value of the temporary register is the smallest value. When there exist two or more values ln of the temporary register with which the value is the smallest value, the REG detector 37 takes the smallest n to be the value of l′.

Further, the REG detector 37 takes the smallest value ln of the temporary register to be the value of k′. The acquired (k′, l′) by the above represents the index of a REG.

(Step S5) The mapping determiner 38 determines whether or not one of PCFICH and PHICH is mapped to the REG detected by the REG detector 37. When one of PCFICH and PHICH is mapped to the REG detected by the REG detector 37, the mapping determiner 38 proceeds to step S7. When PCFICH or PHICH is not mapped to the REG detected by the REG detector 37, the mapping determiner 38 proceeds to step S6.

(Step S6) The RE mapping unit 39 maps PDCCH corresponding to four REs to the REG detected by the REG detector 37 while adding 1 to m′.

(Step S7) The frequency number adder 36 determines whether or not the symbol number acquired by the REG detector 37 at step S4 is l′=0. When the symbol number acquired by the REG detector 37 is l′=0, the frequency number adder 36 proceeds to step S9. When the symbol number acquired by the REG detector 37 is not l′=0, the frequency number adder 36 proceeds to step S8.

(Step S8) The frequency number adder 36 determines whether or not the symbol number acquired by the REG detector 37 at step S4 is l′=1. When the symbol number acquired by the REG detector 37 is l′=1, the frequency number adder 36 proceeds to step S10. When the symbol number acquired by the REG detector 37 is not l′=1, the frequency number adder 36 proceeds to step S11.

(Step S9) The frequency number adder 36 adds ‘6’ to 10 of the temporary register.

(Step S10) The frequency number adder 36 adds ‘4’ to 11 of the temporary register.

(Step S11) The frequency number adder 36 adds ‘4’ to 12 of the temporary register.

In such a manner as described above, the base station 11 maps PDCCH.

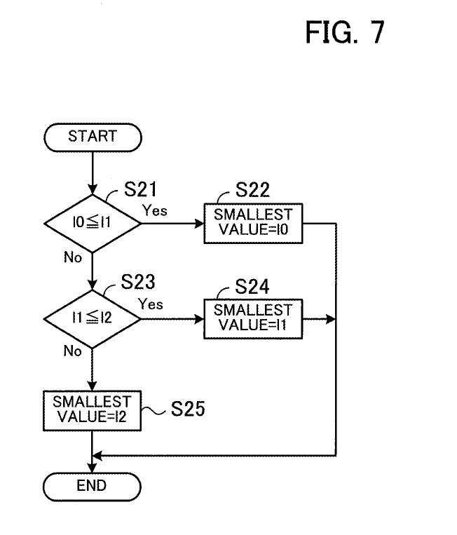

FIG. 7 is a flowchart illustrating processing to detect the smallest value of a temporary register. FIG. 7 illustrates details of the processing at step S3 of FIG. 6.

(Step S21) The REG detector 37 determines whether 10 of the temporary register is equal to or less than 11. When 10 of the temporary register is equal to or less than 11, the REG detector 37 proceeds to step S22. When 10 of the temporary register is not equal to or less than 11, the REG detector 37 proceeds to step S23.

(Step S22) The REG detector 37 detects 10 of the temporary register as the smallest value.

(Step S23) The REG detector 37 determines whether 11 of the temporary register is equal to or less than 12. When 11 of the temporary register is equal to or less than 12, the REG detector 37 proceeds to step S24. When 11 of the temporary register is not equal to or less than 12, the REG detector 37 proceeds to step S25.

(Step S24) The REG detector 37 detects 11 of the temporary register as the smallest value.

(Step S25) The REG detector 37 detects 12 of the temporary register as the smallest value.

In this manner, the base station 11 provides the temporary register corresponding to the symbol number of the RE in the control channel region and stores the frequency number to indicate a REG in the temporary register. The base station 11 detects the temporary register that stores the smallest frequency number of the frequency numbers and when there are two or more temporary registers that store the smallest frequency number, the base station 11 detects the temporary register that stores the smallest frequency number with a smaller symbol number. The base station 11 acquires the symbol number corresponding to the detected temporary register and detects a REG by the acquired symbol number and the smallest frequency number. The base station 11 maps the control channel to the detected REG and adds the next frequency number value to indicate the next REG to the temporary register corresponding to the symbol number of the acquired REG.

Due to this, in the temporary register, the frequency number indicating the REG corresponding to each symbol number is stored. It is not necessary for the base station 11 to determine sequentially whether or not an RE corresponds to a REG for all the REs in the control channel region, and therefore, it is possible to reduce the load of processing to map the control channel to a REG.

For example, it is assumed that the system bandwidth is 5 MHz and the number of OFDM symbols that may be used in the control channel region is three. In this case, if determination of whether an RE of the communication resource corresponds to a REG for all the REs is made, 7/9 of REs are determined to not correspond to a REG, and therefore, the load of processing to map the control channel is large. In contrast to this, it is not necessary for the base station 11 to determine whether or not an RE corresponds to a REG because the temporary register and the stored contents thereof directly indicate a REG. That is, 7/9 of the determination processing, which is wasteful, may be omitted, and therefore, it is possible to reduce the load of processing to map the control channel to a REG.

According to the base station and method for mapping a control channel disclosed above, it is possible to reduce the load of processing to map the control channel to a REG.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A base station that performs allocation of a radio resource, comprising:
a mapping unit configured to allocate a control channel to a resource element group in a control channel region including a plurality of resource elements defined in a time direction and in a frequency direction and identified based on symbol numbers indicating the time direction and frequency numbers indicating the frequency direction;
a storage unit provided corresponding to the symbol number of the resource element in the control channel region and storing the frequency numbers to indicate the resource element group;
a group detector configured to detect the storage unit that stores the smallest frequency number of the frequency numbers and to detect the resource element group based on the symbol number corresponding to the detected storage unit and the smallest frequency number; and
an adder configured to add a predetermined value to indicate a resource element group to which the next control channel is allocated to the smallest frequency number.

2. The base station according to claim 1,
wherein when the two or more storage units that store the smallest frequency number exist, the group detector detects the storage unit having the smaller symbol number.

3. The base station according to claim 1,
wherein the mapping unit allocates the control channel to the resource element group detected by the group detector.

4. The base station according to claim 3, further comprising:
a mapping determiner configured to determine whether or not another control channel has already been allocated to the resource element group detected by the group detector.

5. The base station according to claim 4,
wherein when the mapping determiner determines that the another control channel has been mapped to the resource element group, the mapping unit does not map the control channel to the resource element group.

6. The base station according to claim 1,
wherein the number of resource elements of the resource element group to which the control channel is mapped is determined by the symbol number, and
the predetermined value is the number of the resource elements determined by the symbol number.

7. A method for mapping a control channel of a base station that performs allocation of a radio resource, the method comprising:
allocating a control channel to a resource element group in a control channel region including a plurality of resource elements defined in a time direction and in a frequency direction and identified based on symbol numbers indicating the time direction and frequency numbers indicating the frequency direction;
storing the frequency numbers to indicate the resource element group in a storage unit provided corresponding to the symbol number of the resource element in the control channel region;
detecting the storage unit that stores the smallest frequency number of the frequency numbers;
detecting the resource element group based on the symbol number corresponding to the detected storage unit and the smallest frequency number; and
adding a predetermined value to indicate a resource element group to which the next control channel is allocated to the smallest frequency number.
